(19) United States
(12) Patent Application Publication
(10) Pub. No.: US 2003/0223365 A1
(43) Pub. Date: Dec. 4, 2003

(54) Class of dynamic programming schedulers

(75) Inventor: John M. Kowalski, Camas, WA (US)

Correspondence Address: Robert D. Varitz, ROBERT D. VARITZ, P.C., 2007 S.E. Grant Street, Portland, OR, 97214, US

(73) Assignee: Sharp Laboratories of America, Inc.

(21) Appl. No.: 10/291,018

(22) Filed: Nov. 7, 2002

Related U.S. Application Data
(60) Provisional application No. 60/387,028, filed on Jun. 4, 2002.

(51) Int. Cl. G08C 17/00; H04J 3/00

(52) U.S. Cl. 370/230.1; 370/235; 370/338

(57) ABSTRACT

A scheduler for use in an LAN for allocating transmission opportunities includes a scheduling policy mechanism for assigning flow-to-transmit opportunities to the stations based on network constraints; and an optimization mechanism for looking ahead a number of superframes, N_{L}, to determine an optimal time to assign a transmit opportunity to a station. A method of allocating transmission opportunities includes assigning flow-to-transmit opportunities to the stations based on network constraints; and looking ahead a number of superframes, N_{L}, to determine an optimal time to assign a transmit opportunity to a station.

### RELATED APPLICATION

This Application claims priority from U.S. Provisional Patent Application Serial No. 60/387,028, filed Jul. 1, 2002, for Class of Dynamic Program Scheduler. This Application is related to Class of Computationally Parsimonious Schedulers for Enforcing Quality of Service over Packet-Based AV-centric Home Networks, Ser. No. 10/067,567, filed Feb. 4, 2002.

### FIELD OF THE INVENTION

This invention relates to the ability of a wireless LAN to provide quality of service (QoS), and specifically to the provision of a dynamic method of allocating transmission opportunities in a wireless LAN having a QoS mechanism.

### BACKGROUND OF THE INVENTION

The IEEE's standard for wireless LANs, designated IEEE 802.11, provides two different ways to configure a network: ad-hoc and infrastructure. In an ad-hoc network, computers form a network “on the fly,” with each computer or 802.11 device joining the network is able to send and receive signals. There is no defined structure in an ad-hoc network; there are no fixed points; and every node in the network is able to communicate with every other node in the network. Although it may seem that order would be difficult to maintain in this type of network, sufficient algorithms, such as the spokesman election algorithm (SEA), are provided and are designed to “elect” one machine as the base, or master, station of the network, with the others machines being “slaves.” Another algorithm in ad-hoc network architectures uses a broadcast and flooding method to all other nodes to establish the identity of all nodes in the network.

The infrastructure architecture provides fixed network access points for communications with mobile nodes. These network access points (APs) are sometime connected to land lines to widen the LAN's capability by bridging wireless nodes to other wired nodes. If service areas overlap, handoffs may occur between wireless LANs. This structure is very similar to that used in cellular networks.

The IEEE 802.11 standard places specifications on the parameters of both the physical (PHY) and medium access control (MAC) layers of the network. The PHY layer, which actually handles the transmission of data between nodes, may use either direct sequence spread spectrum, frequency-hopping spread spectrum, or infrared (IR) pulse position modulation. IEEE 802.11 makes provisions for data rates of up to 11 Mbps, and requires operation in the 2.4-2.4835 GHz frequency band, in the case of spread-spectrum transmission, which is an unlicensed band for industrial, scientific, and medical (ISM) applications; and in die 300-428,000 GHz frequency band for IR transmission. Infrared is generally considered to be more secure to eavesdropping, because IR transmissions require absolute line-of-sight links, i.e., no transmission is possible outside any simply connected space or around corners, as opposed to radio frequency transmissions, which can penetrate walls and be intercepted by third parties unknowingly. However, infrared transmissions can be adversely affected by sunlight, and the spread-spectrum protocol of 802.11 does provide some rudimentary security for typical data transfers. The 802.11b physical layer (PHY) provides data rates up to 11 Mbps using a direct sequence spread spectrum (DSSS) approach; while 802.11a provides data rates up to 54 Mbps using an orthogonal frequency division multiplex (OFDM) approach.

The MAC layer includes a set of protocols which is responsible for maintaining order in the use of a shared medium. The 802.11 standard specifies a carrier sense multiple access with collision avoidance (CSMA/CA) protocol. In this protocol, when a node receives a packet to be transmitted, it first listens to ensure no other node is transmitting. If the channel is clear, it then transmits the packet. Otherwise, it chooses a random “backoff factor,” which determines the amount of time the node must wait until it is allowed to transmit its packet. During periods in which the channel is clear, the transmitting node decrements its backoff counter. When the channel is busy it does not decrement its backoff counter. When the backoff counter reaches zero, the node transmits the packet. Because the probability that two nodes will choose the same backoff factor is small, collisions between packets are minimized. Collision detection, as is employed in Ethernet®, cannot be used for the radio frequency transmissions of IEEE 802.11, because when a node is transmitting, it cannot hear any other node in the system which may be transmitting, because its own signal will block any other signals arriving at the node. Whenever a packet is to be transmitted, the transmitting node may first send out a short ready-to-send (RTS) packet containing information on the length of the packet. If the receiving node hears the RTS, it responds with a short clear-to-send (CTS) packet. After this exchange, the transmitting node sends its packet. When the packet is received successfully, as determined by a cyclic redundancy check (CRC), the receiving node transmits an acknowledgment (ACK) packet. This back-and-forth exchange is necessary to avoid the “hidden node” problem, i.e., node A can communicate with node B, and node B can communicate with node C. However, node A cannot communicate node C. Thus, for instance, although node A may sense the channel to be clear, node C may in fact be transmitting to node B. The protocol described above alerts node A that node B is busy, and requires node A to wait before transmitting its packet.

Although 802.11 provides a reliable means of wireless data transfer, some improvements to it have been proposed. The use of wireless LANs is expected to increase dramatically in the future as businesses discover the enhanced productivity and the increased mobility that wireless communications can provide.

IEEE Standard 802.11 (1999) for wireless local area networks (WLAN) does not support Quality of Service (QoS) traffic delivery in its MAC layer. A method to provide Quality of Service traffic delivery for IEEE Standard 802.11 WLAN systems is desirable to enhance communications reliability for 802.11 devices.

There is an 802.11 Task Group e (TGe) joint proposal to support QoS enhancements. Virtual streams having QoS parameter values including priority, data rate, delay bounds and jitter bounds, are supported. The proposal uses a point coordinator (PC) function, featuring reservation request procedures to request new bandwidth allocations. Several new data and management frames are used. New acknowledgement policies, direct station-to-station transfers, basic service set (BSS) overlap management, and dynamic wireless repeater functions are included. This proposal requires modification of the existing 802.11 standard, and may not support, or be supported by, legacy 802.11 devices.

The subject IEEE standard is set forth in ISO/IEC 8802:1999(E) IEEE Std 802.11, 1999 edition, International Standard [for] Information Technology—Telecommunications and information exchange between systems-Local and metropolitan area networks—Specific Requirements—Part11: Wireless LAN Medium Access Control (MAC) and Physical Layer (PHY) specifications.

Previous disclosures on schedulers for Wireless LANs have provided a relatively static method for, allocating transmission opportunities (TxOPs) for wireless LANS having QoS mechanisms. The related application describes a method for scheduling of polls by a “point coordination” function, i.e., a centralized function in a wireless LAN that governs when channel resources are allocated. This particular point coordination function (PCF) differs from the legacy IEEE 802.11 standard by allowing polls to appear at any time during a “Superframe,” e.g., a period of time central to 802.11 systems.

U.S. Pat. No. 6,262,980 to Leung et al, granted Jul. 17, 2001, for Dynamic resource allocation method and apparatus for broadband services in a wireless communications system describes a scheduling algorithm to coordinate the transmission of a number of base stations in a wireless network, rather than to achieve QoS objectives of latency, jitter, and bandwidth for real-time AV transmission.

U.S. Pat. No. 6,229,795 to Pankaj et al., granted May 8, 2001, for System for allocating resources in a communication system describes a contention-based allocation of resources.

U.S. Pat. No. 6,094,426 to Honkasalo et al., granted Jul. 25, 2000, for Method for scheduling packet data transmission describes a soft-handoff methodology.

U.S. Pat. No. 6,049,549 to Ganz et al., granted Apr. 11, 2000, for Adaptive media control describes a polling policy based on monitoring data transmission including retransmission statistics, and assigning communication resources includes adjusting data rate requirements in accordance with the collected retransmission statistics. The patent does not describe adaptation of periods for missed polls, nor the definition of a polling policy to distribute polls and transmit opportunities uniformly on a transmission period.

U.S. Pat. No. 6,157,614 to Pasternak et al., granted Dec. 5, 2000, for Wireless ATM network with high quality of service scheduling describes a system which does not include a scheduling policy.

U.S. Pat. No. 5,638,371 to Raychaudhuri et al., granted Jun. 10, 1997, for Multiservices medium access control protocol for wireless ATM system, describes a TDMA system which does not have a scheduling policy.

SBM (Subnet Bandwidth Manager) RFC2814: A Protocol for RSVP-based Admission Control over IEEE 802-style networks (http://www.ietforg/rfc/rfc2814.txt), defines a specification for interaction of SBM clients, but does not describe how to schedule transmission opportunities from a stochastic or point-coordinated multiple access system.

The use of RSVP[Resources ReSerVation Protocol] with Integrated Services RFC2210 (http://www.ietf.org/rfc/rfc2210.txt) specification determines what information elements are sent between RSVP clients to maintain Quality of Service, and describes information that is passed between bandwidth management entities, but does not describe how to implement a policy based on them.

A. Mok, et al., Real-Time Scheduling of Multimedia Tasks, TR-98-14 (http://www.cs.utexas.edu/users/UTCS/techreports/index/html/Abstracts.1998.html), describes how to determine whether or not a particular task can be scheduled at all over a network, but does not deal with the issue of meeting specified QoS objectives.

### SUMMARY OF THE INVENTION

A scheduler for use in an LAN for allocating transmission opportunities includes a scheduling policy mechanism for assigning flow-to-transmit opportunities to the stations based on network constraints; and an optimization mechanism for looking ahead a number of superframes, N_{L}, to determine an optimal time to assign a transmit opportunity to a station.

A method of allocating transmission opportunities includes assigning flow-to-transmit opportunities to the stations based on network constraints; and looking ahead a number of superframes, N_{L}, to determine an optimal time to assign a transmit opportunity to a station.

It is an object of the invention to allocate transmission opportunities in a dynamic manner in a wireless LAN.

Another object of the invention is to provide optimized transmission opportunities in a wireless LAN.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts a tree diagram for slot allocation for the example problem, for first flow transmitted in the first TxOP.

FIG. 2 depicts a tree diagram for slot allocation for the example problem, for third flow transmitted in the first TxOP.

### DETAILED DESCRIPTION OF THE PREFERRED EMBODIMENTS

This invention offers an optimal method of scheduling transmission opportunities (TxOPs) in a local area network (LAN). The LAN may be a hard-wired system, a wireless system, or may be a powerline LAN. The primary use for the scheduler and method of the invention is in ad hoc networks which do not have a per se control entity. The optimization criterion may be either minimum queue size, or maximizing throughput. This is done via use of Bellman's Dynamic Programming Algorithm. As in the related application, this invention describes a method for scheduling of polls by a “point coordinated” function, i.e., a centralized function in a wireless LAN that governs when channel resources are allocated. The polls appear in the proper time sequence to allow a plurality of wireless LAN stations (“stations”) to maintain QoS objectives to the higher layers. The polls' scheduling is dynamically, and is optimally updated to minimize transmit queue size or maximize throughput.

This invention provides a polling sequence determination, based on inputs from a Bandwidth Management (BWM) entity, to maintain QoS objectives of rate, latency, and jitter as presented from the source MAC Service Access Point (SAP) to its corresponding receiver(s) SAP.

The invention uses the constraints imposed by objectives for delay, jitter, and throughput to develop a tree. Bellman's Algorithm is applied to solve the integer programming problem, thus optimizing throughput, or used to search for the minimum (maximum) path where the objective is minimum queue size (maximum throughput), i.e., maximization over a set with a finite number of elements, inherent in scheduling of fixed-period TxOPs.

A mechanism for assigning transmit opportunities (TxOPs) to stations, i.e., mobile WLAN devices, instead of the prior art technique of associating traffic flows with stations, is described. This is achieved merely by replacing the word “flow” in the pseudo-code in the attachment with “station,” which, in effect, aggregates TxOPs of a plurality of flows to the transmitting STA, from which the flows emanate.

A scheduling algorithm for wireless packet data networks with Quality of Service (QoS) goals includes parameter sets for latency, jitter and bandwidth. A wireless system is able to schedule transmissions in intervals, wherein each interval is Tₛ seconds long, and wherein Tₛ roughly corresponds to IEEE 802.11e's notion of a “superframe,” or beacon interval. There are F flows that the scheduler must assign slots, i.e., transmission opportunities, TxOPs, in 802.11e parlance, for every superframe, to each flow f₁, for i=1 to F.

A number of assumptions are made: It is assumed that there is a time index, j, indicating discrete time. With no loss in generality, it is assumed that the slot times are an integer multiple of the discrete time units. For the purpose of scheduling, a model which allows for packets to flow into transmit queues is required, and the invention includes such a model. It is assumed that at each time j, and that for each flow f, a packet arrives into each transmit queue. With some probability, p₀, the packet length is zero.

For each flow, a sequence in discrete time, {pⱼ^{f}}, of packets; pⱼ^{f} corresponds to the packet in flow f arriving in the transmit queue at time j. Likewise, the following parameters are defined:

τⱼ^{f} as the wireless delay corresponding to packet pⱼ^{f},

λⱼ^{f} as the length of pⱼ^{f},

rⱼ^{f} as the data rate associated with pⱼ^{f},

And, finally, a “scheduling delay” is defined as sⱼ^{f}, which aids in the definition of a “rate clock”

$$RC ( {p}_{j}^{f} ) = j + ( \frac{{λ}_{j}^{f}}{{r}_{j}^{f}} ) + {τ}_{j}^{f} + {s}_{j}^{f}$$

where RC(pⱼ^{f}) represents the time the packet is expected to be received at the receiver.

The scheduling delay is the delay that is chosen by the scheduler to transmit the packet. Thus, the allocation of TxOPs is equivalent to the choice of sⱼ^{f} for each packet. Of course, for any fixed time j, the scheduler can only schedule one packet at a time. It is also assumed, for the same reason that from a single flow only one packet may be scheduled at a time as well.

At some time, e.g., t₀, prior to transmission, each queue has some information stored, which is to be transmitted over the air wirelessly subject to certain constraints, so as to either maximize or minimize some “measure of goodness,” which is called the objective. The constraints considered are:

1. The overall rate of the wireless channel is constrained to be less than C_{MAX},

2. Each flow can be transmitted over wireless channel at rate c_{f}, which is possibly different for each flow,

3. The latency and jitter bounds, D_{f} and γ_{f} respectively.

For the particular applications in which we are interested, streams are generally constant bit rate (CBR), however, the method of the invention may be extended in a straightforward way to non-CBR streams.

Thus, from the above constraints, there are 3F constraints in the allocation of TxOPs.

Having described the constraints associated with this problem to be solved, the objective of the scheduler will be described, e.g., what the scheduler attempts to optimize. Two criteria for objectives come to mind:

1. Maximization of throughput, and

2. Minimization of pending transmit queue sizes.

In performing the scheduling computations, scheduling policies that optimize either of the above criteria may be selected. The invention primarily focuses on the second criteria, however, if throughput is defined as:

$$P = {\sum }_{j = i}^{i + j} {\sum }_{f = 1}^{F} {λ}_{j}^{f T}$$

where λⱼ^{fT} represents the length of a packet from flow f at time j successfully transmitted, then this invention may be used for this criterion once appropriate changes are made. The time index j here is arbitrarily taken to be from j=1, but this of course is arbitrary and works with any time j dynamically.

The second criteria may be expressed as follows: qⱼ^{f} is the length of the queue, e.g., in octets, of the queue of pending traffic, i.e., traffic waiting to be transmitted, in the f-th flow at time j. The performance measure corresponding to minimization of transmit queues is thus expressed as:

$${P}^{′} = {\sum }_{j = i}^{i + j} {\sum }_{f = 1}^{F} {q}_{j}^{f }$$

where i is the time in which the optimization is done. Typically the scheduler will “look ahead” in time, especially in regard to the scheduling of CBR streams. Thus the problem statement is: allocate TxOPs to each flow, according to the constraints 1-3 above, such that either P or P′ is optimized. Any given solution will be an allocation of transmit opportunities, and schedule delays for each packet in each flow over which the optimization will be considered.

It is assumed that scheduling decisions are made for each superframe. Decisions may be made for groups of superframes, or for groups of TxOPs, which would reduce computation, possibly at the loss of some optimally.

Solution to the Scheduling Problem

The solution to the scheduling problem may be approached as follows: A key to the solution is to keep track of constraints across superframe boundaries. In order to arrive at the solution, another piece of notation must be introduced, namely, the concept of a “scheduling policy,.” where:

Â=[f₁, f₂, . . . , fₙ, . . . ],

where f is the flow arriving in the transmit queue at scheduling interval n, and Â is a tentative assignment of flows-to-transmit opportunities, conditioned on meeting the constraints. If a scheduling decision is made every superframe, at the k-th superframe,

Âₖ=[f₁, f₂, . . . , fₙ, . . . f_{NS}],

where NS denotes the number of transmit opportunities (TxOPs) in a superframe, or scheduling opportunity, which may have up to seven TxOPs, and fₙ is a tentative assignment of a particular flow to the n-th transmit opportunity in the frame. Now, considering successive tentative Âₖ's, i.e., a succession tentative scheduling policies. If, at the k-th superframe, Âₖ is a tentative scheduling policy for that superframe, that policy may restrict the possible succeeding polices Âₖ₊₁, Âₖ₊₂, etc., because of the nature of the constraints 1-3. Thus, any Âₖ must have at least one particular predecessor, Âₖ₋₁, although it may have more than one particular predecessor, depending on the nature of the constraints, and the number of Âₖ's successors, i.e., the number of possible Âₖ₊₁'s for which Âₖ is a predecessor, in general, will be far fewer than F^{NS}.

Definition of Scheduling Policy Mechanism

At this point, recognizing the above, the “principle of optimally” may be invoked, by an optimization mechanism which is the same device used to derive, in other contexts, the Viterbi Algorithm. Given that all scheduling decisions up to Âₖ₋₁ are optimal, then the optimal solution for Âₖ is that which minimizes the queue size, or other criterion, over the relevant number of superframes for which the optimization is carried out. The solution may be extended to “look ahead” at superframes for Âₖ₊₁, Âₖ₊₂, etc., to determine what the best choice should be for Âₖ; in general, the number of frames to “look ahead” would be governed by considerations such as:

a. current queue size limits and predictions of flow into the transmit queue, and

b. latency and jitter constraints.

For example, if the jitter requires one to have no more than 20 ms between “outflows” of transmission from a given queue, if the superframe duration were 5 ms, a time that is short compared to 802.11 typical superframe times, one would typically have to “look ahead” four superframes in advance before making a scheduling decision on the current superframe.

The actual implementation of the algorithm is now straightforward. The algorithm is presented via pseudo-code, using above-described conventions with additional notation as follows:

Let N_{L} = the number of superframes to “look ahead.”

| 0. | At time k, with schedule at A*ₖ₋₁ (the superscript * denotes that |
|---|---|
| | this is the optimal choice for a schedule, and is not tentative), do: |
| | For i=0 to N_{L}−1 % Loop on number of frames to look ahead |

For n=1 to NS %Loop on number of TxOPs

For f=1 to F % Loop on flows

Can (fₙ in Aₖ₊₁) be assigned to flow f?
If (YES) then:
Does that assignment determine future assignments
of flows due to constraints?

IF (YES) then:
A)Make those provisional assignments to all
future TxOPs. (This has the effect of updating
the loop indices “n” and “i” above for this
assignment of f, at this particular starting
“n” and “i”)
B) Compute revised queue lengths
C) Carry out all further computations for this
assignment based on the number of transmit
ops this assignment affects.
D) Goto to next choice of f for the “starting”
value of “n” and “i” prior to the first “YES”
above. (This goes to the next place
systematically on the “tree” of possible Âₖ's.)
E) Store Candidate for next loop
END IF

ELSE
F) Store Candidate for next loop
Update queue length computations based on
provisional transmission

Continue

Continue

Continue

1. Choose (from among the) provisional state assignment(s), based on the constraint set, one with the smallest remaining queue size.

Note that in the pseudo-code step 0.C, the constraints are used, and the scheduler algorithm then “looks ahead” to possible Âₖ's and TxOP assignments based on the constraints. Also note that since this scheduling algorithm is an integer programming problem, i.e., it is optimizing over discrete sets of numbers, a unique, single optimal solution may not exist. However, this algorithm will find a solution such that there is no better solution, although there may be equal solutions. The algorithm will identify equivalent solutions.

Solution of this algorithm is equivalent to finding a path through a tree, which comes about from the constraints.

Example Problem and Solution

In the following simplified problem, which does not rely on specific 802.11 parameters, the numbers are chosen to make the arithmetic come out easily. In the case of an actual 802.11 solution, of course, the allocations are made within the time allotted to the Hybrid Coordinator. Using the notation previously employed, let:

F=3, e.g., consider 3 flows, all at constant bit rate transmission;

Tₛ=100 ms, this superframe time may correspond to an actual 802.11 superframe time;

NS=4, The number of TxOPs per superframe (NSₘₐₓ=7);

N_{L}=the number of superframes the scheduler computes with, set at 2;

T_{TxOP}=25 ms, assuming that there is no contention period in the superframe to simplify matters. This is the granularity of TxOPs assigned. Exactly one TxOP is assigned in each 25 ms slot, and there are exactly four TxOPs per 100 ms superframe. The term “slot” and TxOP are used interchangeably, noting that this is not the “slot” time associated with IEEE 802.11;

D₁=D₂=75 ms;

D₃=200 ms;

τ₁=τ₂τ₃=0, for the actual wireless system, this delay will also include retransmission delays, which may be accounted for statistically;

γ_{f}^{o}|sⱼ^{f}−sⱼ₋₁^{f}|=D_{f} for f=1,2,3, For f=1,2 and let the rate at which the channel requires transmission be 5 Mbps, i.e., the rate of flow into the transmit queue. Let the rate of flow into the transmit queue for f=3 be 2 Mbps. Furthermore, let the transmit rate, i.e., the rate over the channel, be either 10 Mbps or 20 Mbps for flows 1 and 2, and 10 Mbps for flow 3.

In each 25 ms slot, flows 1 and 2 are able to transmit over the air 50000 bits or 62,500 bytes, at 20 Mbps, and flow 3 transmits 250000 or 31250 bytes. At 10 Mbps, flows 1 and 2 are able to transmit 31250 bytes in each 25 ms slot over the air.

At time j=0, assume that:

q₀^{f}=2 Mbytes, for streams 1 and 2 and for stream 3, q₀³=1 Mbyte.

Finally, assume that λⱼ^{f}=15625 bytes, or λⱼ^{f}=25×10⁻³×5×10⁶/8bits/byte, for f=1,2. For f=3, let λⱼ³=6250 bytes or λⱼ³=25×10⁻³×2×10⁶/8bits/byte, which is invoking the constant bit rate (CBR) assumption. For flows 1 and 2, an assignment of a TxOP sends out four packets, and for flow 3, five packets are sent out.

Because the queues are initially non-empty, flows 1 and 2 are minimized by transmitting at the highest possible rate. Once the queues are emptied, they can be transmitted at the lower rate. Assume that the data arrives at a constant rate; in every 25 ms slot time, then, qⱼ¹ either experiences an increase of 15625 bytes or a net decrease of 46875 bytes, depending on whether or not the slot is assigned to flow 1. A similar result holds for flow 2, and for flow 3, that queue either experiences an increase of 6250 bytes or a net decrease of 25000 bytes. This is summarized in the Table 1, below:

TABLE 1
Net Queue Sizes When Transmitted at the Maximum Rate

| | Net change in queue if | Net change in queue if |
|---|---|---|
| | TxOP assigned to that | TxOP NOT assigned to |
| Flow | flow (bytes) | that flow (bytes) |
| 1 | −46875 | 15625 |
| 2 | −46875 | 15625 |
| 3 | −25000 | 6250 |

If a slot is assigned, e.g., to flow 1, then the net change in all queues will be −15625 bytes. The same answer will be for an assignment to flow 2, and for flow 3 the answer will be 6250 bytes, i.e., a net increase in queue sizes.

Summarizing in a Table 2:

TABLE 2

| Flow Selected in 1 TxOP | Net Change in ALL Queues |
|---|---|
| 1 | −15625 bytes |
| 2 | −15625 bytes |
| 3 | 6250 bytes |

In the interest of making the explanation and problem easier, the practical effect of the above constraints result in the following Assignment Rules:

1. Because the queues are initially non-empty, flows 1 and 2 are minimized by transmitting at the highest possible rate. Once the queues are emptied, they can be transmitted at the lower rate, and indeed must be, to accommodate the latency and jitter constraints of this problem.

Consider a policy carried out over multiple slots, and let it be denoted as:

Â=[f₁, f₂, . . . , fₙ, . . . ]

2. If flow 1 is assigned to TxOP fₙ then if fₙ₊₁, and fₙ₊₂ are not assigned to flow 1, then fₙ₊₃ must be assigned to flow 1.

3. If flow 2 is assigned to TxOP fₙ then if fₙ₊₁ and fₙ₊₂ are not assigned to flow 2, then fₙ₊₃ must be assigned to flow 2.

4. For any assignment that is optimal, there exists another assignment with flows 1 and 2 exchanged, because they have identical parameters.

5. An assignment to flow 3 must be made at least as often as every other superframe to meet delay/jitter requirements, but in order to meet throughput requirements, and not to have queue 3 overflow, it is necessary, on the average to give at least one TxOP every 5 slots.

6. Finally, note that for flows 1 and 2, they need to be transmitted according to their rates, every 75 ms, which means that their minimum rate has to be at least 10 Mbps, e.g., at least 2 slot assignments every 4 slots, when transmitted at a 20 Mbps rate, and an actual throughput rate of 5 Mbps when transmitted at a 10 Mbs.

These rules, which are inferences made from the rate, delay, and jitter parameters, may be programmed into the software by some “inference engine.” In general, they are supplied by the station requesting a parameterized QoS flow by signalling its transmission specification (T_{SPEC}). In the execution of the actual algorithm, essentially the constraints are constantly checked with each slot to see which ones needed to be invoked. The inferences above, however, allow a quick solution to the algorithm for checking the constraints.

Now, following the previously mentioned algorithm, and starting from step 0, initialize i=0, n=1, thus considering possible assignments for Â₁=[1, f₂, ff₃, f₄], where fₙ is a tentative assignment of a flow to f=1, 2, or 3.

First Pass on Loop on Flows (i=0, n=1)

If f₁=1,2, or 3 there are no constraints on f₂. Thus, there are three provisional policies from the first slot: one beginning with each of f=1,2, and 3. These three provisional policies are stored.

Loop on Flows (i=0, n=2)

There are three candidates from before the last loop Â₁=[1, f₂, f₃, f₄], Â₁=[2, f₂, f₃, f₄], and Â₁=[3, f₂, f₃, f₄]. With Â₁=[1, f₂, ff₃, f₄].

If f₂=1, then, from the above Assignment Rules, f₃=2, and Â₁=[1, 1, 2, f₄], must be used; [111 . . . ] and [113 . . . ] are forbidden.

If f₂=2, no constraints need to be invoked yet, so this result is stored:

If f₂=3, then, from the above Assignment Rules, f₃=2, and Â₁=[1, 3, 2, f₄], must be used; [131 . . . ] and [133 . . . ] are forbidden. So, for this candidate, at n=2, there are three successors: [1, 1, 2, f₄], [1, 2, f₃, f₄], and [1, 3, 2, f₄]. Note that the number of successors, with no constraints at all, are 3³=27, but instead, there are less than 3+9+3=15 successors.

With Â₁=[2, f₂, ff₃, f₄], the result is the same as above, only with “1” and “2” exchanged. (These entries are not computed herein, as they will yield the same result as above.)

With Â₁=[3, f₂, f₃, f₄], if f₂=1, f₃=2, if f₂=2, f₃=1, and f₂=3, is forbidden because either 1 or 2 will have its delay/jitter constraint violated. Therefore, the successors for f₁=3, are: [3, 1, 2, f₄] and [3, 2, 1, f₄].

(End of loop for n=2)

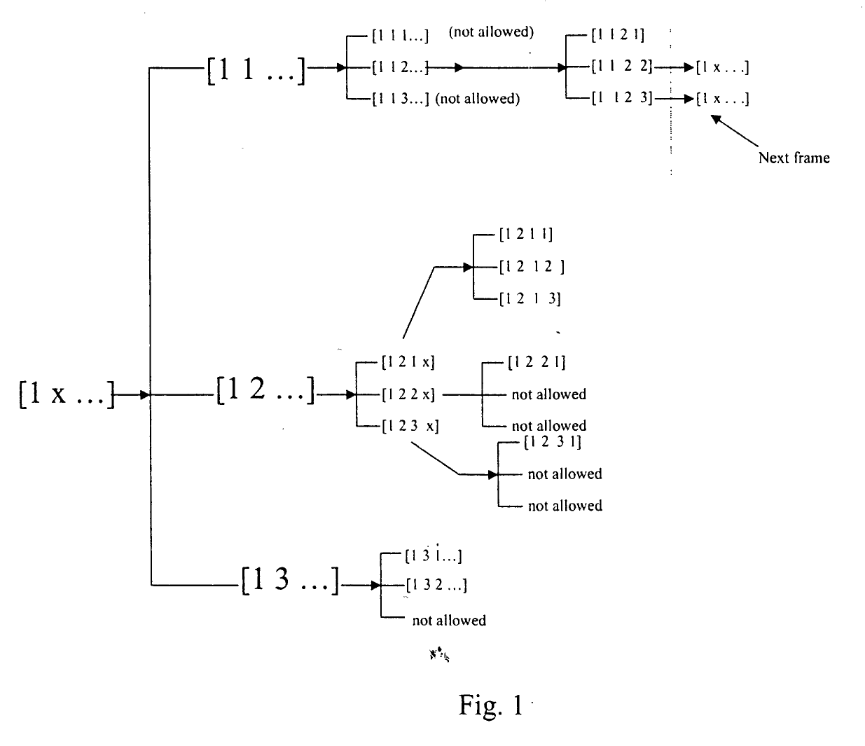

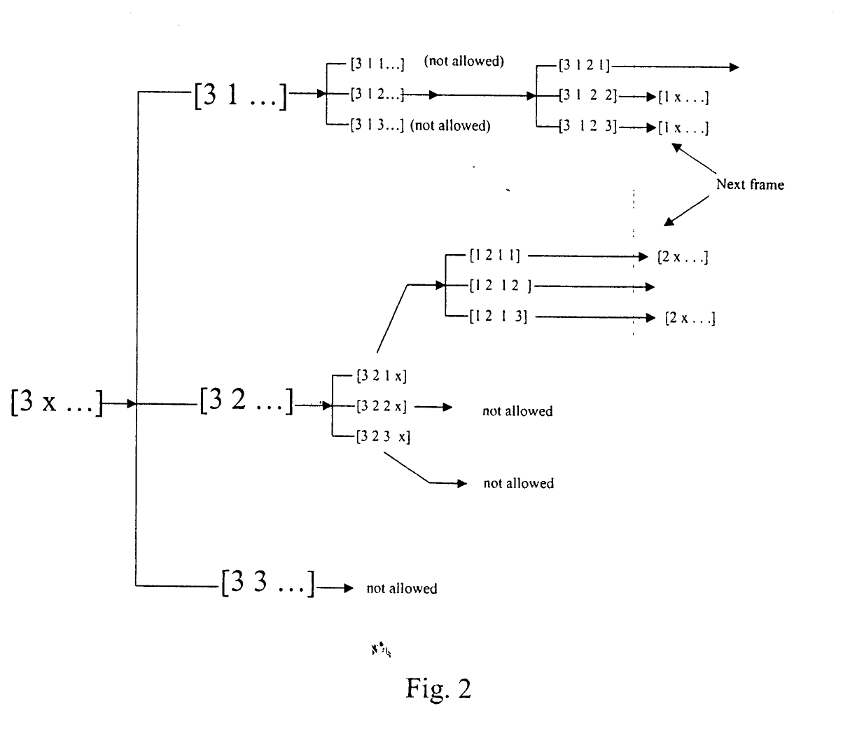

From the above, a “tree” listing may be constructed, which is shown in FIGS. 1 and 2, for allocations with the first allocation being the first flow, and the first allocation being the third flow, respectively. There are, after this allocation, 26 possible allocations, keeping in mind the same number of “survivors” starting with flow 2 is the same from flow 1. A diagram for the second flow transmitted in the first TxOP is the same as FIG. 1, with “1” and “2” interchanged. The lower part of the tree has not been completed for purposes of clarity.

From the trees of FIGS. 1 and 2, and Tables 1 and 2, the net change in all queues may be computed and evaluated. Any allocation with a “flow 3” in it, remembering that there can be only one flow 3 allocation, has a net change of −40625 bytes. Any allocation without a “flow 3” has −62500 bytes. Now, if there were no “look ahead,” specifically seeing what the effect of the constraints on flow 3 would be, any allocation without a “flow 3” will be optimal. But if the look-ahead value is more than 2 frames, any allocation must have a flow 3 in the second superframe if there is not a flow 3 present in the first superframe. Thus, the optimal allocation has at least one “flow 3” in one of the first 2 superframes, which must also meet the delay/jitter constraints for flows 1 and 2. In “steady state,” i.e., when the queues have essentially only “incoming” traffic, and do not contain data stored from a (long) previous history, allocations obeying rules 1 to 6, above, are sufficient for optimal scheduling. If schedules are being met for flows then, as would be expected for a system like 802.11, nothing whatsoever will be scheduled/allocated. Finally, although this example does not have a single unique solution, it is possible to conceive of problems that do have a unique solution, which would be used to test for the existence of this algorithm, or one like it.

Implementation Considerations

The above algorithm, if employed for scheduling thousands of transmit opportunities, becomes computationally infeasible because there is a dependency between the number of flows F and the number of TxOPs per superframe NS, and the number of superframes computed in scheduling, NL, that will, absent constraints, go as F^{NS*NL}. However, instead of scheduling the TxOPs individually, they may be scheduled in blocks, which may or may not be contiguous in time, greatly reducing the computational burden of the problem. In particular, it is possible to “pre-allocate” TxOPs to certain CBR flows, and schedule a small fraction of “additional flows” to account for retries that will have to be performed. It should be noted, however, that solutions for the “coarsely quantified” scheduler might not be optimal compared to the “finely quantified” scheduler, but they would have the advantage of being computationally feasible.

Thus, a method for centralized scheduling of parameterized flows to achieve Quality of Service has been described. A solution to this problem exists based on the Dynamic Programming algorithm. This algorithm may be scaled for real time computation. It will be appreciated that further variations and modifications thereof may be made within the scope of the invention as defined in the appended claims.

I claim:

1. In a local area network, having a plurality of stations, and wherein data flow moves over the network in superframes, a scheduler for allocating transmission opportunities, comprising:
a scheduling policy mechanism for assigning flow-to-transmit opportunities to the stations based on network constraints; and
an optimization mechanism for looking ahead a number of superframes, N_{L}, to determine an optimal time to assign a transmit opportunity to a station.

2. The scheduler of claim 1 wherein the network constraints include (1) the overall rate of the wireless channel is constrained to be less than C_{MAX}, (2) each flow can be transmitted over wireless channel at rate c_{f}, which is possibly different for each flow, and (3) the latency and jitter bounds.

3. The scheduler of claim 1 wherein said scheduling policy mechanism schedules transmit opportunities to minimize queue size and to maximize throughput on a channel.

4. The scheduler of claim 3 where throughput is defined as:
$$P = {\sum }_{j = 1}^{i + J} {\sum }_{f = 1}^{F} {λ}_{j}^{f T}$$
where λⱼ^{fT} represents the length of a packet from flow f at time j successfully transmitted, and j is the time index; and wherein queue minimization is represented by:
$${P}^{′} = {\sum }_{j = 1}^{i + J} {\sum }_{f = 1}^{F} {q}_{j}^{f }$$
where i it the time in which the optimization is done and qⱼ^{f} is the length of the queue.

5. The scheduler of claim 4 wherein transmit opportunities are allocated to each flow such that P or P′ is optimized.

6. The scheduler of claim 5 wherein transmit opportunities are identified in groups of up to seven transmit opportunities in a superframe.

7. The scheduler of claim 1 wherein said scheduling policy is defined by:
A=[f₁, f₂, . . . , fₙ, . . . f_{NS}],
where A is the tentative assignment of flows-to-transmit opportunities; f is the flow arriving in the transmit queue at scheduling interval n and NS is the number of transmit opportunities in a superframe.

8. The scheduler of claim 1 which operates according to a protocol defined by:
At time k, with schedule at A*ₖ₋₁, do:
For i=0 to N_{L}−1 % Loop on number of frames to look ahead
For n=1 to NS %Loop on number of TxOPs
For f=1 to F % Loop on flows
Can (fₙ in Aₖ₊₁) be assigned to flow f?
If (YES) then:
Does that assignment determine future
assignments of flows due to constraints?
IF (YES) then:
A)Make those provisional assignments to
all future TxOPs;
B) Compute revised queue lengths;
C) Carry out all further computations for
this assignment based on the number of
transmit ops this assignment affects;
D) Goto to next choice of f for the
“starting” value of “n” and “i” prior to the
first “YES” above;
E) Store Candidate for next loop;
END IF;
ELSE;
F) Store Candidate for next loop;
Update queue length computations based on
provisional transmission;
Choose (from among the) provisional state assignment(s), based on
the constraint set, one with the smallest remaining queue size.

9. The scheduler of claim 1 wherein the local area network is a network taken from the group of networks consisting of wireless local area networks, hard-wired local area networks and power-line local area networks.

10. In a local area network, having a plurality of stations, and wherein data flow moves over the network in superframes, a method of allocating transmission opportunities, comprising:
assigning flow-to-transmit opportunities to the stations based on network constraints; and
looking ahead a number of superframes, N_{L}, to determine an optimal time to assign a transmit opportunity to a station.

11. The method of claim 10 wherein the network constraints include (1) the overall rate of the wireless channel is constrained to be less than C_{MAX}, (2) each flow can be transmitted over wireless channel at rate c_{f}, which is possibly different for each flow, and (3) the latency and jitter bounds.

12. The method of claim 10 which includes optimizing the system, including maximizing throughput and minimizing pending transmit queue size, including a scheduling policy mechanism for scheduling transmit opportunities to minimize queue size and to maximize throughput on a channel.

13. The scheduler of claim 12 where throughput is defined as:
$$P = {\sum }_{j = 1}^{i + J} {\sum }_{f = 1}^{F} {λ}_{j}^{f T}$$
where λⱼ^{fT} represents the length of a packet from flow f at time j successfully transmitted, and j is the time index; and wherein queue minimization is defined as:
$${P}^{′} = {\sum }_{j = 1}^{i + J} {\sum }_{f = 1}^{F} {q}_{j}^{f }$$
where i it the time in which the optimization is done and qⱼ^{f} is the length of the queue, and wherein said optimizing includes either maximizing throughput or minimizing transmit queue size.

14. The scheduler of claim 13 wherein said optimizing includes allocating transmit opportunities to each flow such that P or P′ is optimized.

15. The scheduler of claim 14 wherein said optimizing includes identifying transmit opportunities in groups of up to seven transmit opportunities in a superframe.

16. The scheduler of claim 10 wherein said looking ahead includes a scheduling policy wherein:
A=[f₁, f₂, . . . , fₙ, . . . f_{NS}],
where f is the flow arriving in the transmit queue at scheduling interval n and A is the tentative assignment of flows-to-transmit opportunities.

17. The method of claim 10 which operates according to a protocol defined by:
At time k, with schedule at A*ₖ₋₁, do:
For i=0 to N_{L}−1 % Loop on number of frames to look ahead
For n=1 to NS %Loop on number of TxOPs
For f=1 to F % Loop on flows
Can (fₙ in Aₖ₊ᵢ) be assigned to flow f?
If (YES) then:
Does that assignment determine future
assignments of flows due to constraints?
IF (YES) then:
A)Make those provisional assignments to
all future TxOPs;
B) Compute revised queue lengths;
C) Carry out all further computations for
this assignment based on the number of
transmit ops this assignment affects;
D) Goto to next choice of f for the
“starting” value of “n” and “i” prior to the
first “YES” above;
E) Store Candidate for next loop;
END IF;
ELSE;
F) Store Candidate for next loop;
Update queue length computations based on
provisional transmission;
Choose (from among the) provisional state assignment(s), based on
the constraint set, one with the smallest remaining queue size.

18. The method of claim 10 wherein the local area network is a network taken from the group of networks consisting of wireless local area networks, hard-wired local area networks and power-line local area networks.
